(19) United States
(12) Patent Application Publication
(10) Pub. No.: US 2006/0169535 A1
(43) Pub. Date: Aug. 3, 2006

(54) Barrier crossover device

(76) Inventors: Alexander K. Phillips, River Forest, IL (US); Donald L. Stadel, Elizabeth, IL (US)

Correspondence Address: Bell, Boyd & Lloyd LLC, P.O. Box 1135, Chicago, IL, 60690-1135, US

(21) Appl. No.: 11/039,046

(22) Filed: Jan. 18, 2005

(51) Int. Cl. E06C 7/16

(52) U.S. Cl. 182/119

(57) ABSTRACT

A barrier crossover device which is transportable between different remote locations to enable a user to cross over a barrier such as a fence. The crossover device includes a first support and a second support hingedly connected together and a pair of side members. The side members each include at least one step and are connectable to the first and second supports on each side of the crossover device. The crossover over device also includes a platform which is positionable over at least two of the steps and adapted to support the weight of a user. The crossover device includes a pair of base members each including a stabilizer which are movably connected to each side member to adjust the height of the crossover device. Each stabilizer being movable through the base members to secure the base members in the underlying support surface.

### BACKGROUND OF THE INVENTION

Several different types of ladders, step stools and other devices exist to perform different functions. Some ladders such as extension ladders are used to reach high places such as second floor windows or gutters on a house. These ladders are typically portable and thereby transferable from one location to the next. Smaller type ladders such as step ladders are used to reach areas which are just out of a person's reach such as the top shelf of a cabinet, a light on the ceiling or other similar area. Smaller step stools are also used by smaller people such as children to reach sinks, table tops or other areas which are otherwise difficult for the children to get to. Therefore, ladders assist users to perform a number of different functions.

Ladders or step devices also include platforms which are connected to the ladders and hold a container, tools or other devices for a user while the user performs some function such as painting a wall or ceiling. Other similar devices such as portable scaffolding, are used to provide more stable platforms and work areas to perform these functions.

Similarly, on farms, ranches and other similar areas, farmers, fishermen or hunters use fixed bridge-like structures or platforms having steps to enable them to crossover a fence or other barrier on the farms or remote locations to get from one part of the location to another. These structures are semi-permanent structures which can not be easily moved or transferred from one location to the next. Because these structures are not easily movable to a covered storage area such as a barn, garage or shed, these structures are exposed to the elements and deteriorate or breakdown over time. Also, because the structures are typically permanently placed in a particular location, a user most cross a barrier at that particular location where the structure is located even though the user may be a great distance away from a desired location to which they are attempting to get to.

Accordingly, there is a need to overcome the forgoing disadvantages.

### SUMMARY OF THE INVENTION

The present invention is directed to a portable barrier crossover device and more specifically to a portable and foldable or collapsible crossover device which can be disassembled, easily transported and quickly setup at remote locations to enable the user to crossover a barrier such as a fence or wall.

In one embodiment, a barrier crossover device is provided which includes a pair of first supports and second supports, each first support being hingedly connected to a corresponding one of the second supports. The crossover device includes a pair of side members, where each of the side members includes a first side rail and a second side rail. The first side rail and the second side rail each including a proximal end and a distal end, where the proximal ends of each of the first side rails are removably connected to the first support and the proximal ends of each the second side rails are removably connected to the second support. The crossover device also includes a plurality of steps connected to the first side rail and the second side rail of each of the side members, where each step is positioned in a substantially horizontal plane. The crossover device includes a platform removably connected to each of the side members, where the platform is positionable on at least two of the steps and adapted to support a weight of at least one user. The crossover device also includes at least one base member connected to the distal ends of the first and second side rails and at least one securing device removably connected to each of the base members.

In an embodiment, the crossover device includes a first cross support connected at one end to the first side rail of one of the side members and at an opposite end to the first side rail of the other side member. The first cross support being adjustable to adjust the angle between the first side rail of one of the side members and the first side rail of the other side member.

In another embodiment, the crossover device includes a second cross support connected at one end to the second side rail of one of the side members and at an opposite end to the second side rail of the other side member. The second cross support being adjustable to adjust the angle between the second side rail of one of the side members and the second side rail of the other side member.

In an embodiment, the crossover device includes at least one connector connected to the proximal ends of each of the first side rails and the first support.

In another embodiment, the connector includes a D-ring connector.

In an embodiment, the crossover device includes at least one connector connected to the proximal ends of each of the second side rails and the second support.

In another embodiment, the connector includes a D-ring connector.

In an embodiment, the platform includes a non-slip surface.

In another embodiment, each of the steps includes a non-slip surface.

In an embodiment, the platform is adapted to support the weight of a plurality of users.

In an embodiment, the crossover device includes at least one corrosion resistant coating applied to at least one of the pair of hinge members, pair of side members, steps, first and second cross supports, platform, base member and securing device.

In another embodiment, the crossover device includes at least one hook connected to at least one of the side members, where the hook is adapted to receive a line member.

In an embodiment, the line member includes at least one of: a chain, a cable and a rope.

In another embodiment, the crossover device includes at least one stop connected to each of the base members.

Another embodiment of the barrier crossover device is provided where the crossover device includes a first ladder portion and a second ladder portion. The first and second ladder portions each including at least one step. Additionally, the portable crossover device includes a first hinge member and a second hinge member each including two supports. One of the supports of the first and second hinge members is connected to the first ladder portion and the other of the supports of the first and second hinge members is connected to the second ladder portion. The supports of each of the first and second hinge members are pivotable to adjust the angle between the supports of the first and second hinge members. The crossover device also includes a platform positioned on corresponding steps of the first and second ladder portions and at least two adjustable stabilizers connected to each of the first ladder portion and the second ladder portion. The stabilizers are movable with respect to the first and second ladder portions to adjust the position of each of the first and second ladder portions.

In an embodiment, the crossover device includes a first cross support having two ends, where one of the ends is connected to the first ladder portion and the other of the ends is connected to the second ladder portion.

In another embodiment, the crossover device includes a second cross support having two ends, where one of the ends is connected to the first ladder portion and the other of the ends is connected to the second ladder portion.

Another embodiment of the barrier crossover device is provided where the crossover device includes a pair of top assemblies, where each of the top assemblies includes a first support hingedly connected to a second support, and a pair of bottom assemblies each including a proximal end and a distal end. Each of the bottom assemblies being removably connected to a corresponding one of the top assemblies at the proximal end and including a plurality of steps. The crossover device including a plurality of feet assemblies, where at least one of the feet assemblies is connected to the distal end of the bottom assemblies. The crossover device further includes a platform removably connected to each of the bottom assemblies. The platform being positionable on at least two of the steps of the bottom assemblies and adapted to support a weight of at least one user.

In an embodiment, the crossover device includes a first cross support connected to each of the bottom assemblies.

In another embodiment, the crossover device includes a second cross support connected to each of the bottom assemblies.

Accordingly, an advantage of the present invention is to provide a barrier crossover device which enables a user to easily and quickly transport the device, set up the device and crossover a barrier at a remote location.

Another advantage of the present invention is to provide a barrier crossover device which enables a user to adjust the angle between opposing sides of the device to adjust the device for different barrier widths.

A further advantage of the present invention is to provide a barrier crossover device which enables a user to adjust the height of the device to accommodate for different terrains and barrier heights.

Another advantage of the present invention is to provide a barrier crossover device which includes a removable platform which supports the weight of at least one user and enables a user to crossover from one side of the device to the other side of the device.

Additional features and advantages of the present invention are described in, and will be apparent from, the following Detailed Description of the Invention and the Figures.

### BRIEF DESCRIPTION OF THE FIGURES

FIG. 1 is a perspective view of one embodiment of the Barrier Crossover Device.

FIG. 2 is an exploded perspective view of the Barrier Crossover Device of FIG. 1.

FIG. 3 is an front elevation view of the Barrier Crossover Device of FIG. 1, wherein the rear elevation view is identical to this view.

FIG. 4 is a right side view of the Barrier Crossover Device of FIG. 1, where the left side view is identical to this view.

FIG. 5A is an enlarged fragmentary perspective view of the connected portion of the top support member and the bottom support member of the Barrier Crossover Device of FIG. 1.

FIG. 5B is an enlarged fragmentary perspective view of one end of the cross support of the Barrier Crossover Device of FIG. 1, wherein the cross support is connected to the bottom support member on one side.

FIG. 6 is an enlarged fragmentary perspective view of the top support, the bottom support and the cross support on one side of the Barrier Crossover Device of FIG. 1.

FIG. 7A is a schematic view of one embodiment of the base support of the Barrier Crossover Device of FIG. 1, wherein the base support is in a generally upright non-engaged position with respect to the underlying support surface.

FIG. 7B is a schematic view of one embodiment of the base support of the Barrier Crossover Device of FIG. 1, wherein the base support is in a generally engaged position with respect to the underlying support surface.

### DETAILED DESCRIPTION OF THE INVENTION

The present invention is directed to a barrier crossover device and more specifically to a portable, foldable or collapsible crossover device which can be disassembled, easily transported and quickly setup at remote locations to enable a user to crossover a barrier such as a fence or wall.

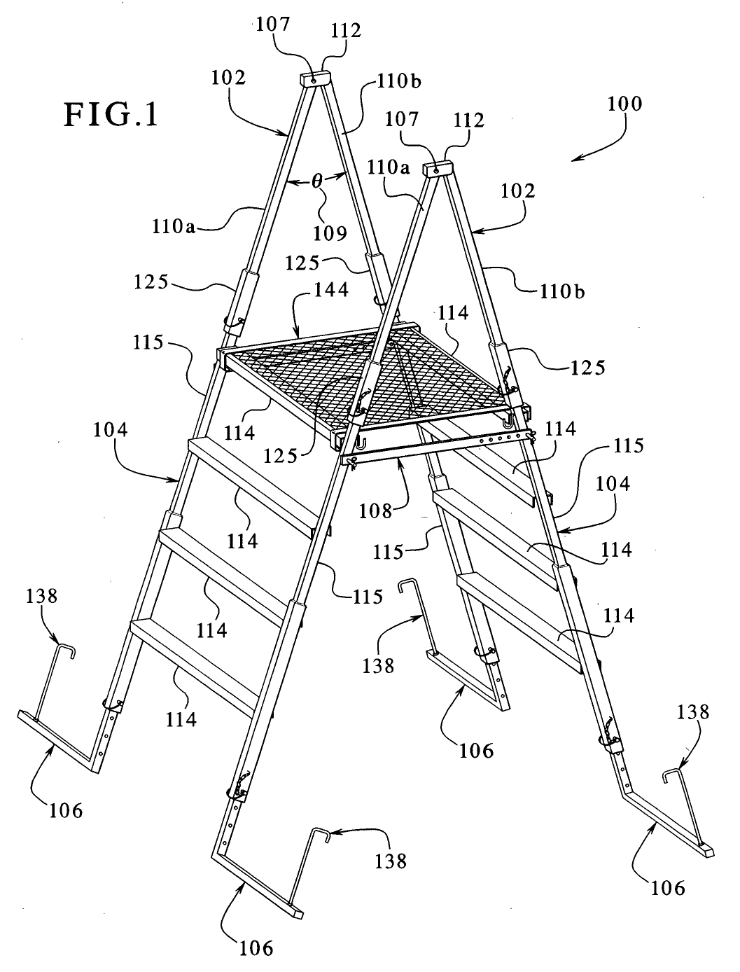

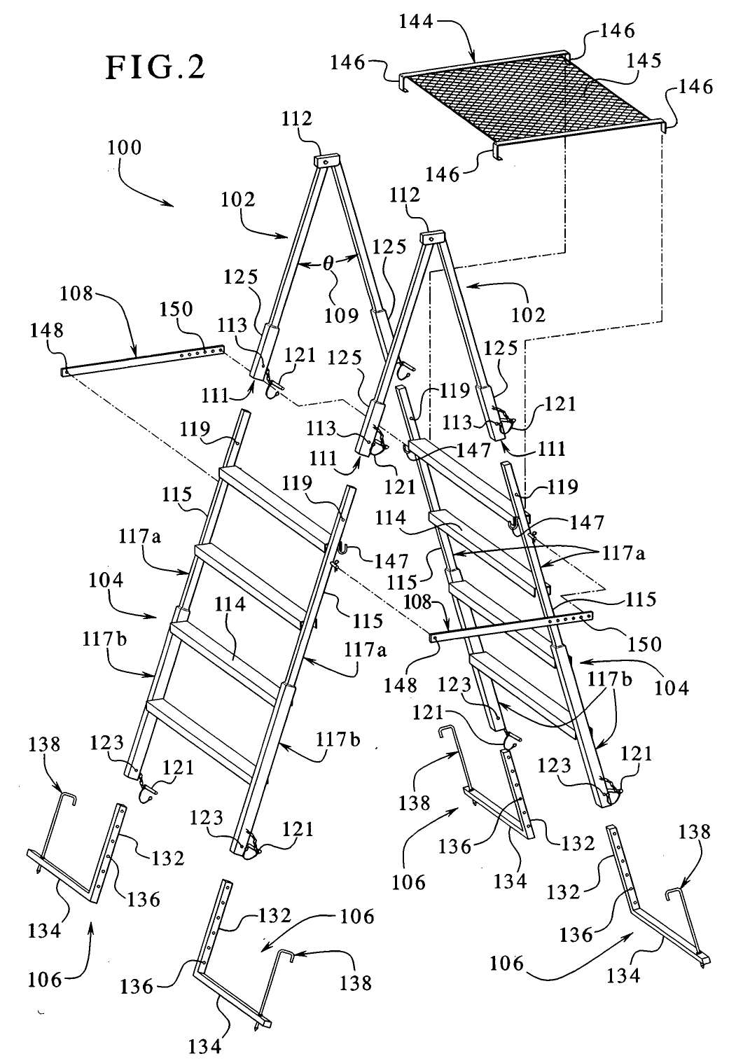

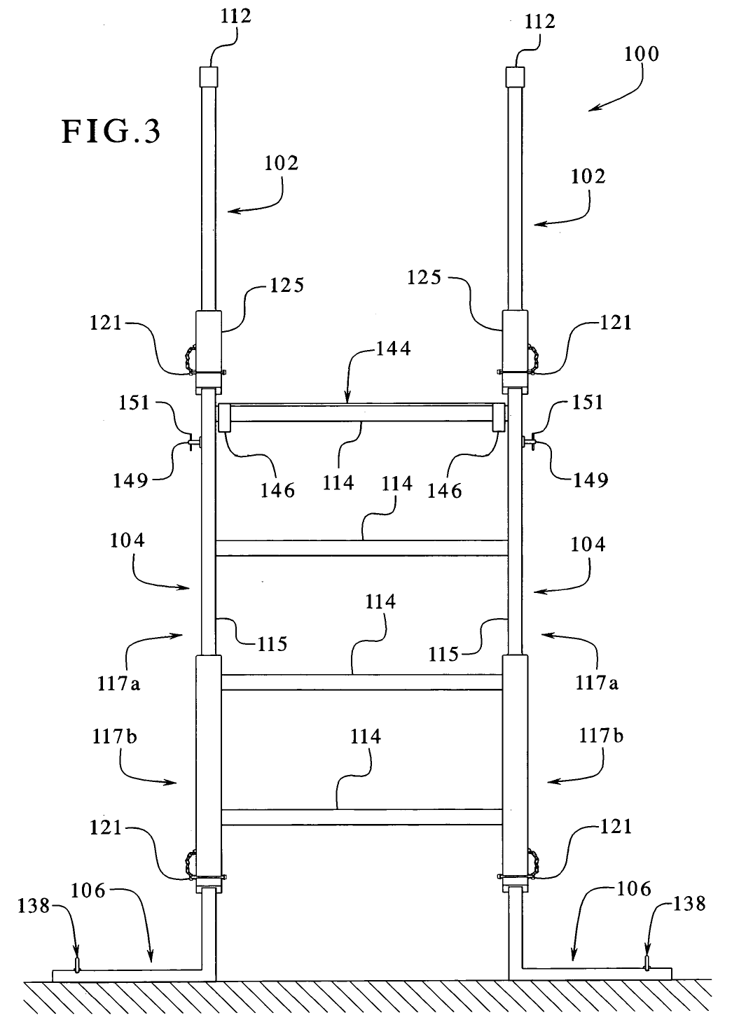

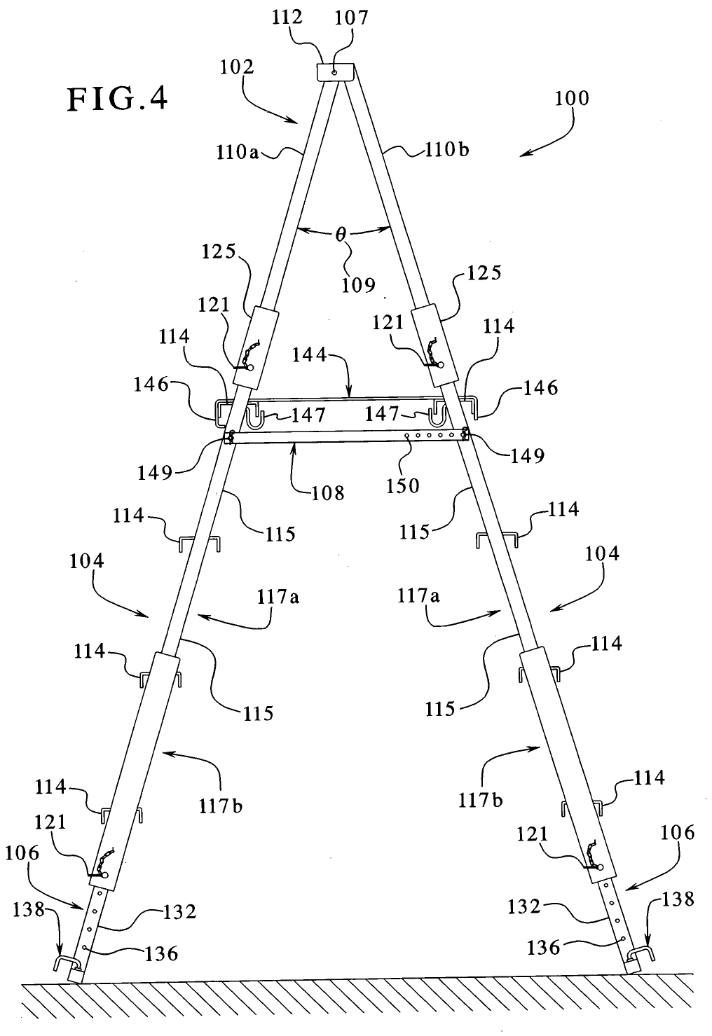

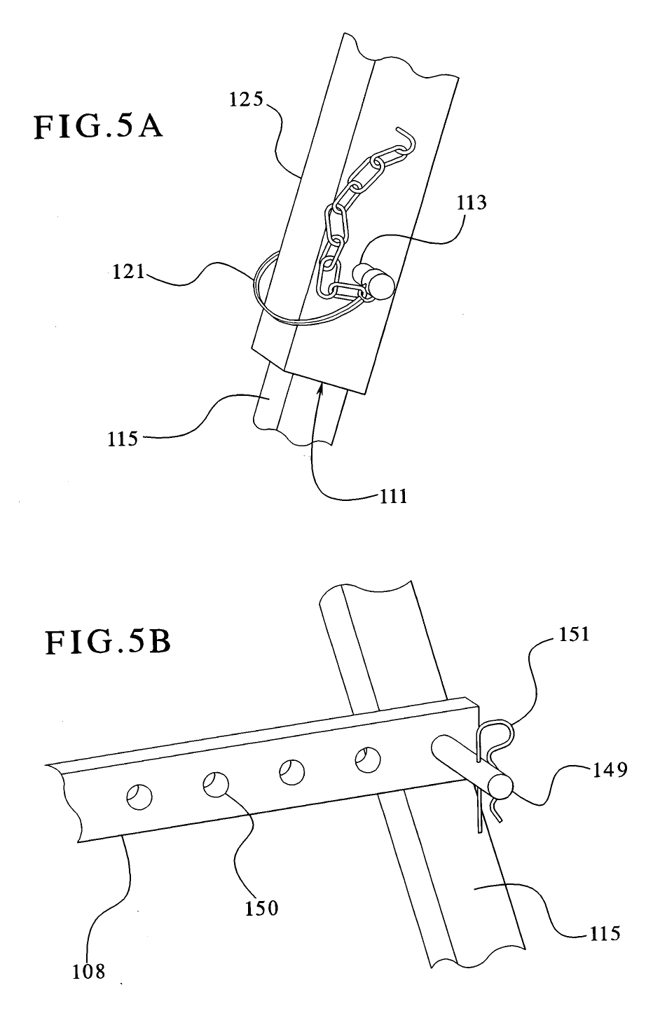

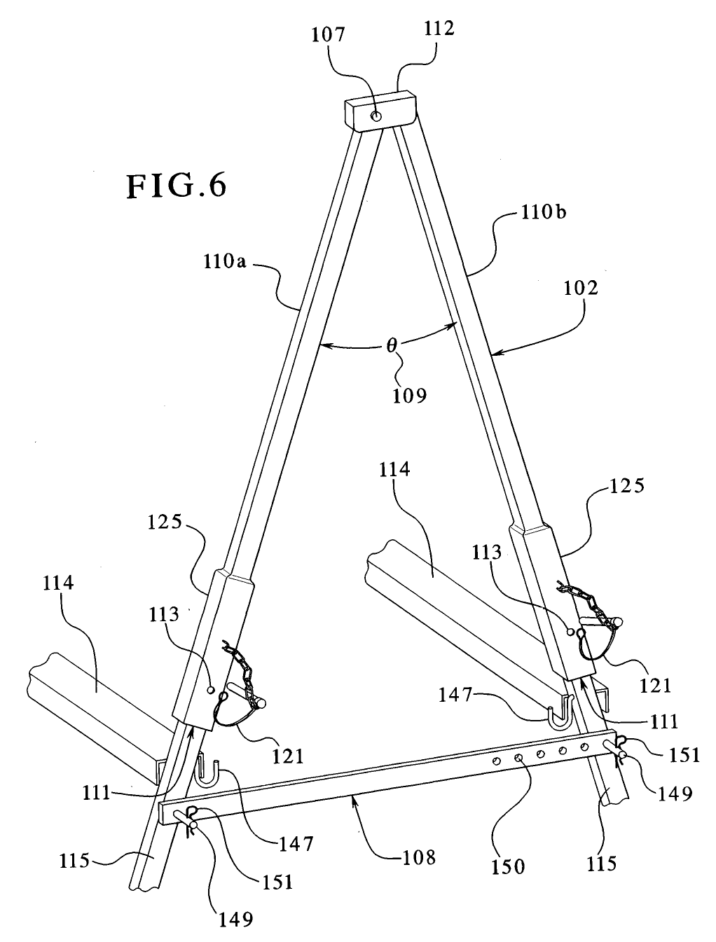

Referring to FIGS. 1 to 7B, in one embodiment, the portable barrier crossover device or crossover device 100 includes a pair of top assemblies or support members 102, a pair of bottom assemblies or support members 104 which are each connected to the top support members on each side of the top support member, feet assemblies or base supports or stabilizers 106 which are adjustably connected to each of the bottom support members 104 to adjust the height of each side of the crossover device and cross supports 108 which are adjustable and secure a designated angle Θ labeled as 109 formed between the different sides of the crossover device and provide stability to the crossover device.

In one embodiment, each of the top assemblies or support members 102 include a first support 110a and a second support 110b. The first and second supports each define elongated hollow shafts or channels which each include a proximal end or top end and a distal end, bottom end or adapter 125. The proximal end or top end of each of the first and second supports 110a and 110b, respectively, is hingedly or pivotably connected to a hinge member 112 using a connector such as a bolt 107 or any other suitable connector. Each hinge member 112 is a substantially horizontal planar member which is connected to the first and second supports and enables the first and second supports to move or pivot towards and away from each other. This enables the top support members 102 to be folded together and thereby allows a user to fold and store or transport the portable crossover device 100. The distal end or bottom end 125 of each of the first and second supports 110a and 110b define an opening, hole or receptacle 111 which is sized and shaped to receive and connect to the bottom support members 104 as explained in detail below. In one embodiment, the size of the receptacle 111 is the same as the size and shape of the top end of each of the first and second supports. In the illustrated embodiment, the receptacle 111 is a larger size and shape than the top end of each of the first and second supports. In one embodiment, the bottom ends 125 define a hole or opening 113. The hole or opening 113 extends through each side of the first and second supports and is sized to receive a fastener or connector such as a D-ring connector 121, cotter pin, bolt or other suitable connector.

In the illustrated embodiment, the bottom support members, ladder assemblies or ladder members 104 include side rails 115 and steps 114 which are positioned between the side rails 115 and are connected to each of the side rails. In this embodiment, the side rails 115 define elongated hollow shafts or channels similar to the first and second supports described above. Each of the side rails 115 include a smaller sized top end 117a and a larger sized bottom end 117b. The smaller sized top ends 117a of each of the side rails are sized and shaped to at least partially fit into or within the receptacles 111 at the bottom ends 125 of the first and second supports 110a and 110b, respectively, of the top support members 102. Specifically, the top ends 117a of each of the side rails define a hole or opening 119 which are aligned with the openings 113 at the bottom ends of the first and second supports when the top ends 117a of the side rails are inserted into the bottom ends of the first and second supports.

In the illustrated embodiment, a fastener or connector such as a D-ring connector 121 is inserted into and through the aligned openings 113 and 119 to secure each bottom support member 104 to the top support members 102. In one embodiment, the D-ring connector 121 is attached to the bottom support members using a stabilizing member or chain which is welded at one end to the D-ring connector and at an opposing end to a surface of the bottom support member. It should be appreciated that the connector may be any suitable fastener or connector. It should also be appreciated that the connector may be connected to the bottom support member using any suitable connection device. Additionally, the connector may be a separate component which is not attached to the bottom support member.

As described above, one or more steps 114 are connected to the side rails 115 as shown in the figures. In one embodiment, each step is a substantially horizontal planar member and provides a stable surface for a user to step onto and climb upward or downward on each side of the crossover device 100. In one embodiment, each end of the steps 114 is connected to each of the side rails by welding the ends of the steps to the side rails. It should be appreciated that any suitable connection method may be used to connect the ends of the steps to the side rails. Each of the steps 114 are substantially horizontal or positioned to be substantially horizontal to provide a stable, level stepping surface for a user. In one embodiment, at least a portion of each step is manufactured with (or otherwise includes) a suitable tread or a partially raised surface to provide a substantially non-skid or non-slip surface for a user. In another embodiment, a substantially non-skid or non-slip coating is applied to each step. In a further embodiment, a substantially non-skid or non-slip material is applied to one or more of the steps to help prevent a user's foot from slipping on the steps. It should be appreciated that any suitable non-skid, non-slip or substantially slip resistant surface, coating or material may be used on or applied to one or more of the steps.

In the illustrated embodiment, the larger sized bottom ends 117b of each of the side rails are sized and shaped to receive the feet, base supports or stabilizers 106 as described in detail below. Each bottom end 117b defines a hole or opening 123. A D-ring connector 121 is connected to the bottom ends 117b of each of the side rails using a chain which is welded at one end to the D-ring connector and at an opposing end to a surface of the bottom support member as described above.

In one embodiment, each foot, stabilizer or base support 106 is adjustably or movably connected to one of the bottoms ends 117b of each of the side rails 115 of the bottom support members 104. Each of the stabilizers 106 are generally L-shaped members. The stabilizers each include a height adjuster or an adjustment member 132 integrally connected to a base or foot 134. The adjustment member 132 defines a plurality of holes or openings 136 which are equally spaced along the adjustment member and extend through the adjustment member. It should be appreciated that the openings may be spaced at the same or different distances from each other along the adjustment member to enable a user to adjust one or more of the stabilizers 106 to a suitable position or height.

To adjust or set the position of each stabilizer 106, one of the openings 136 defined by the stabilizer (which corresponds to the desired position or height of the stabilizer) is aligned with the opening or hole 123 defined by the bottom end 117b of the side rails. The adjustable stabilizers 106 enable a user to adjust the height of each stabilizer (i.e., each side of the crossover device) and thereby enable a user to adjust the height, position and stability of the crossover device 100. Different openings or holes 136 of each stabilizer may be aligned with the opening 123 to adjust the position of each of the stabilizers. After the openings or holes are aligned, a suitable connector such as the D-ring connector 121 connected to the bottom end 117b of the side rails is inserted into and through the aligned openings to secure the stabilizers to the bottom support member. Once the user has set and secured the stabilizers at the desired height or position, the user is ready to secure the stabilizers in place with respect to the underlying support structure or ground surface.

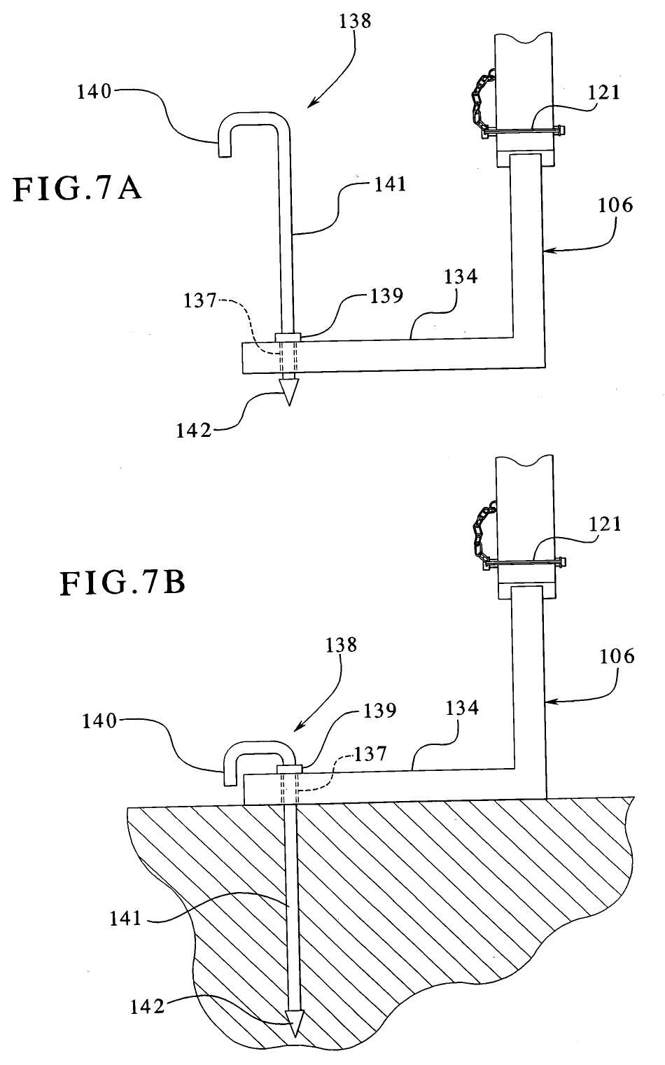

In one embodiment, an anchor, stake or ground support 138 is movably connected to each base or foot 134 of each of the stabilizers. As best illustrated in FIGS. 7A and 7B, each ground support 138 includes a U-shaped member 140 and an upright member 141. In the illustrated embodiment, the U-shaped member and upright member 140 and 141 are integrally formed or connected together. It should be appreciated that the U-shaped member and the upright member may be separate parts which are connected together. The stake or ground support 138 is movably connected to an opening 137 defined by the base or foot 134 of each of the stabilizers. The opening 137 is sized to enable the stake 138 to move upward and downward with respect to the base or foot 134.

In one embodiment, a rubber flange, ring or stop 139 is movably connected to each stake 138 above the opening 137 in the base or foot 134. The stop 139 is made of a resilient material such as a suitable rubber and temporarily holds the stake 138 in place. When a user applies a designated amount of pressure to the stake to move the stake downward through the opening 137, the stake 138 slides through the stop 139. The stop 139 enables each stake to be maintained in a desired position such as an upright position while the stabilizers are being adjusted to the desired height on each side of the crossover device and also prevents the stakes from dangling from the bottom of the stabilizers during transport.

In the illustrated embodiment, a flange or protrusion 142 is integrally formed with the stake 138 and is positioned below the bottom surface or the base or foot 134. In operation, the stake 138 remains connected to the base or foot 134 of each of the stabilizers. The flange 142 helps to prevent the stakes from being pulled up through the openings 137 defined by the stabilizers and removed or lost. Once the stabilizers are adjusted, a user steps on the stakes or uses a tool such as a hammer or mallet to push or knock the stack 138 downward through the opening 137 and into the ground or underlying support surface or structure located beneath each of the stabilizers. In one embodiment, the flange 142 is shaped to have a pointed end, piercing end, wedge-shaped or arrow-shaped head as shown in the figures to more easily penetrate the ground or other support surface beneath the crossover device and secure the crossover device to the ground surface. The U-shaped member 140 also prevents the stake from moving through the opening 137 and away from the crossover device and provides a suitable place for a user to place their fingers to grab and manipulate the stakes upward or downward with respect to the base member 106.

When the stakes are firmly pushed and secured into the ground, a user places a substantially planar user support or platform 144 at a desired height on the crossover device 100. The platform 144 is made of a durable material such as a stainless steel and preferably includes a mesh webbing or middle section 145 to enable rain, snow or other weather elements to pass through the platform while maintaining the rigidity or stability of the platform. The platform is also durable and strong enough to support the weight of at least one user.

The platform 144 includes two securing members or stops 146 on each end of the platform. The platform is placed over corresponding steps 114 on each side of the crossover device (which are preferably at the desired height for the platform) so that the stops are positioned on the outside surface of each of the steps. Generally, the platform is placed on steps that are at the same height on each side of the crossover device so that the platform is substantially level or horizontal to provide a stable, level crossover surface or stepping surface for a user. The stops 146 help to prevent the platform from moving or sliding over the steps 114 and possibly causing the platform to move or fall while being used. Additionally, the stops 146 help to prevent the opposing bottom support members 104 from moving further apart, which helps stabilize the crossover device during use.

In operation, a user sets up the crossover device 100 as described above and then climbs or descends the steps 114 to the platform 144. It should be appreciated that the components of the crossover device 100 described above may be assembled in any suitable order. The platform 144 is generally positioned on the steps so that the top portion of the top support members act as support railings or handles for a user to grab onto to provide more stability while crossing over a fence or other barrier. Additionally, the platform is positioned at a suitable height that is above the top surface of the platform but above the top surface of the fence or other barrier so that the user can crossover that barrier. Once the user crosses over the platform, the user descends or climbs down the steps 114 on the opposite side of the crossover device. When the user reaches the ground or underlying support surface, the user has successfully crossed over the barrier and then may disassembly the crossover device to transport it to a different area or location.

In the illustrated embodiment, one or more cross supports 108 are connected to the opposing side rails 115 of the bottom support members 104 as shown in the figures to further stabilize the crossover device and to enable a user to adjust the angle Θ (labeled as 109) between the bottom support members. Each cross support 108 is generally an elongated rectangular member which extends between the opposing side rails and is removably connected to the opposing side rails on each side of the crossover device as shown in the figures. Each cross support defines a single hole 148 at one end of the cross support and a plurality of holes 150 at an opposite end of the cross support. The hole 148 is aligned with a corresponding extender, pin or post 149 integrally formed on the side rails. The post 149 is sized to fit through the opening 148 of the cross supports 108. Each post 149 defines an opening sized to receive a suitable connector such as a cotter pin 151. Each cotter pin 151 is connected to each side rail using a chain or similar connector as described above. The chain prevents the cotter pins from being lost during transport and/or storage of the crossover device. It should be appreciated that the platform 144 provides stability to the crossover device and helps to maintain the angle 109 as described above. The cross supports 108 therefore provide further support to the crossover device and are not necessary to the function of the crossover device.

In the illustrated embodiment, a user adjusts the angle Θ (labeled as 109) between the sides of the crossover device 100 by moving or pivoting the first and second supports toward or away from each other about the hinge member 112 until a desired angle is achieved and a corresponding hole 150 is positioned over the post 149 on the opposing side rail. A suitable connector such as the cotter pin 151 described above is inserted through an opening in the post to secure the cross support in place. The other cross support is connected in the same way. A user may remove the connectors and adjust the position of the cross supports to adjust the angle between the sides of the crossover device as needed.

It should be appreciated that the components of the crossover device 100 may be manufactured using any suitable material such as stainless steel or a polymer. It should also be appreciated that the components of the crossover device 100 may be manufactured using any suitable material.

In one embodiment, one or more of the components of the portable, foldable or collapsible crossover device 100 are coated with a corrosion resistant coating which helps to prevent corrosion such as rust. It should be appreciated that any suitable corrosion resistant coating may be applied to the components of the crossover device.

In another embodiment, a coating such as a suitable paint is applied to one or more components of the portable crossover device to enhance or change the appearance of the crossover device. For example, a camouflage coating is applied to the crossover device to help hide the appearance of the crossover device in hunting areas. It should be appreciated that any suitable coating or paint may be applied to a portion or all of the crossover device. It should also be appreciated that the coating or paint may also be corrosion resistant or rust-proof.

In another embodiment, one or more holders or hooks 147 are connected to the bottom support members. The hooks 147 are welded or otherwise connected to the bottom support members using a suitable connector or connectors. A user attaches one end of a support line such as a chain (not shown) to the hook and wraps the chain about a support structure such as a fence. The other end of the chain is attached to a hook connected to the opposite side of the crossover device. It should be appreciated that any suitable support line such as a chain, cable, rope or other suitable device may be used to aid in securing secure the crossover device.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

1. A barrier crossover device comprising:
a pair of first supports and second supports, each first support being hingedly connected to a corresponding one of said second supports;
a pair of side members, each of said side members including a first side rail and a second side rail, said first side rail and said second side rail each including a proximal end and a distal end, wherein the proximal ends of each first side rail are removably connected to the first support and the proximal ends of each second side rail are removably connected to the second support;
a plurality of steps connected to said first side rail and said second side rail of each of said side members, wherein each step is positioned in a substantially horizontal plane;
a platform removably connected to each of said side members, said platform being positionable on at least two of said steps and adapted to support a weight of at least one user;
at least one base member connected to the distal ends of said first and second side rails; and
at least one securing device movably connected to each of said base members.

2. The crossover device of claim 1, which includes a first cross support connected at one end to said first side rail of one of said side members and at an opposite end to said first side rail of said other side member, said first cross support being adjustable to adjust the angle between the first side rail of said one of said side members and said first side rail of said other side member.

3. The crossover device of claim 2, which includes a second cross support connected at one end to said second side rail of said one of said side members and at an opposite end to said second side rail of said other side member, said second cross support being adjustable to adjust the angle between the second side rail of said one of said side members and said second side rail of said other side member.

4. The crossover device of claim 1, which includes at least one connector connected to the proximal ends of each of the first side rails and the first support.

5. The crossover device of claim 4, wherein said connector includes a D-ring connector.

6. The crossover device of claim 1, which includes at least one connector connected to the proximal ends of each of the second side rails and the second support.

7. The crossover device of claim 6, wherein said connector includes a D-ring connector.

8. The crossover device of claim 1, wherein said platform includes a non-slip surface.

9. The crossover device of claim 1, wherein each of said steps include a non-slip surface.

10. The crossover device of claim 1, wherein said platform is adapted to support the weight of a plurality of users.

11. The crossover device of claim 1, which includes at least one corrosion resistant coating applied to at least one of the first and second supports, pair of side members, steps, platform, base member and securing device.

12. The crossover device of claim 1, which includes at least one hook connected to at least one of the side members, said hook adapted to receive a stabilizing member.

13. The crossover device of claim 1, wherein the stabilizing member includes at least one of: a chain, a cable and a rope.

14. The crossover device of claim 1, which includes at least one stop connected to each of said base members.

15. A barrier crossover device comprising:
a first ladder portion and a second ladder portion, said first and second ladder portions each including at least one step;
a first hinge member and a second hinge member each including two supports, one of said supports of said first and second hinge members connected to the first ladder portion and said other of said supports of said first and second hinge members connected to said second ladder portion, wherein the supports of each of said first and second hinge members are pivotable to adjust the angle between the supports of the first and second hinge members;
a platform positioned on corresponding steps of the first and second ladder portions; and
at least two adjustable stabilizers connected to each of said first ladder portion and said second ladder portion, wherein said stabilizers are movable with respect to said first and second ladder portions to adjust the position of each of said first and second ladder portions.

16. The crossover device of claim 15, which includes a first cross support having two ends, one of said ends being connected to said first ladder portion and said other of said ends being connected to said second ladder portion.

17. The crossover device of claim 16, which includes a second cross support having two ends, one of said ends being connected to said first ladder portion and said other of said ends being connected to said second ladder portion.

18. A barrier crossover device comprising:
a pair of top assemblies, each of said top assemblies including a first support hingedly connected to a second support;
a pair of bottom assemblies each including a proximal end and a distal end, each of said bottom assemblies being removably connected to a corresponding one of said top assemblies at said proximal end and including a plurality of steps;
a plurality of feet assemblies, at least one of said feet assemblies being connected to said distal end of said bottom assemblies; and
a platform removably connected to each of said bottom assemblies, said platform being positionable on at least two of said steps of said bottom assemblies and adapted to support a weight of at least one user.

19. The crossover device of claim 18, which includes a first cross support connected to each of said bottom assemblies.

20. The crossover device of claim 19, which includes a second cross support connected to each of said bottom assemblies.
